(19) United States
(12) Patent Application Publication
(10) Pub. No.: US 2025/0094878 A1
(43) Pub. Date: Mar. 20, 2025

(54) APPARATUS FOR LOCALLY TRAINING A PRETRAINED MACHINE LEARNING MODEL, A METHOD FOR LOCALLY TRAINING A PRETRAINED MACHINE LEARNING MODEL AND A NON-TRANSITORY COMPUTER-READABLE MEDIUM

(71) Applicant: Intel Corporation, Santa Clara, CA (US)

(72) Inventors: Ofer RIVLIN, Tel-Aviv (IL); Mor UZIEL, Caesarea (IL); Dan HOROVITZ, Rishon Lezion (IL); David BIRNBAUM, Modiin (IL)

(21) Appl. No.: 18/971,060

(22) Filed: Dec. 6, 2024

Related U.S. Application Data
(60) Provisional application No. 63/661,065, filed on Jun. 18, 2024.

(51) Int. Cl. G06N 20/00

(52) U.S. Cl. CPC G06N 20/00

(57) ABSTRACT

It is provided a non-transitory computer-readable medium storing instructions that, when executed by one or more processing circuitries of an apparatus, causing the one or more processing circuitries to perform locally on the apparatus a method. The method includes obtaining a pretrained machine learning model by the apparatus. The method further includes generating training data based on user-related information. The user-related information relating to a user behavior during interaction of the user with the apparatus. The method further includes training the pretrained machine learning model based on the generated training data by the apparatus to obtain a personalized machine learning model. The method further includes executing the personalized machine learning model by the apparatus.

### BACKGROUND

In the field of artificial intelligence (AI) and machine learning (ML), personalized user experiences on endpoint devices, such as personal computers, may be important. Machine learning models may play an important role in enabling customized interactions, allowing systems to adapt intelligently to individual user preferences and behaviors. However, personalization often involves transferring data off-device to external servers for processing, which may introduce potential risks to user privacy and limits control over sensitive information. Furthermore, achieving real-time, user-specific adaptation on local devices may present additional technical challenges, particularly in managing processing efficiency and resource utilization on consumer hardware.

### BRIEF DESCRIPTION OF THE FIGURES

Some examples of apparatuses and/or methods will be described in the following by way of example only, and with reference to the accompanying figures, in which

FIG. 1 illustrates a block diagram of an example of a non-transitory computer-readable medium;

FIG. 2 illustrates a block diagram of an example of an apparatus;

FIG. 3 illustrates a flowchart of an example of a method;

FIG. 4 illustrates a system a distribution of a pretrained machine learning model to edge devices;

FIG. 5 illustrates a flowchart of a fine-tuning process for a pretrained machine learning model to control toast notifications;

FIG. 6 illustrates the evaluation process of a fine-tuned machine learning model;

FIG. 7 illustrates a flowchart of an inference step for a fine-tuned machine learning model to control a toast notification; and

FIG. 8 illustrates a flowchart of the fine-tuning of a pretrained machine learning model and the inference of the fine-tuned machine learning model for controlling a toast notification.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

When a personalized machine learning model is used on a user device, the training and/or inference is often performed externally, outside the user device. This approach may raise data privacy concerns, as transferring private data off the device can compromise user privacy and security.

In previous approaches personalization of a machine learning model may have been provided but user privacy was compromised. For example, learning is conducted on a cloud using users' data is shared with the cloud. Examples of such solutions include virtual assistants like Siri and Google Assistant, which use machine learning to personalize the user experience by learning from voice commands, preferences, and routines. These assistants may even complete sentences based on past interactions, providing a customized experience. Another example is streaming services like Netflix and Hulu, which use machine learning to personalize content recommendations based on what the user has watched before, user ratings, and even the time of day. E-commerce recommendation engines also fall into this category; these machine learning-powered tools analyze past purchases, browsing history, and other data points to suggest products users might find interesting. Examples include Adobe Sensei and Dynamic Yield. However, while these solutions offer personalization, they require data sharing with external servers, which may compromise user privacy.

Other previous approaches may provide no or limited personalization inference on the customer/user's system when using the machine learning model, but do so without “learning”. These approaches may maintain privacy because the machine learning model is stored locally on the user's device, enabling limited personalization that does not require ongoing learning, such as supplying inferences on the user's private documents. In these cases, models are not adapted to users' behavior or preferences, as this would require the model to learn the user's patterns over time. Examples of such solutions include NVIDIA® TensorRT™, an SDK for deep learning inference, which performs personalization by utilizing Retrieval-Augmented Generation (RAG). RAG may allow users to upload documents to give inferences with those documents as a personal context. However, in this approach, the machine learning model may never learn the user's behavior, and TensorRT™ does not employ reinforcement learning. Another example may be the Intel-Labs research POC, which demonstrates inference using a Small Language Model Phi-2 on Intel Meteor Lake. This approach may perform inference only, without learning or personalization based on user behavior.

Another previous approach may be federated learning, which may require a local enclave support on devices and may have inherent performance and size limitations. Although federated learning may support decentralized learning, it faces scalability challenges and may require additional infrastructure to operate efficiently on endpoint devices.

The currently disclosed technique may provide a personalized experience to customers by utilizing their private data directly on their devices while fully preserving data privacy. The learning is accomplished by fine-tuning a pretrained machine learning model on private customer data and using reinforcement learning, all conducted locally at the user device. The machine learning model may be installed on the user device, ensuring that the customer's data never leaves the device or system perimeter. This technique allows the machine learning model to learn and adapt based solely on user-specific data without transferring sensitive information externally. In other words, fine-tuning and reinforcement learning is performed on the machine learning model (for example a small language model), in addition to inference, locally on a user's endpoint system. This technique may provide a privacy-preserving and enhanced personalized experience by utilizing user/customer-specific data directly on the device. The technique may allow for real-time, responsive updates to the machine learning model based on the user's data, which remains securely on the endpoint, ensuring that privacy is maintained without reliance on external servers for learning or processing.

In case of the currently disclosed technique, users' data may not be accessible from outside the system and never leaves the system. This may be achieved by preserving the privacy of customer data and enabling reinforcement learning directly at the end user device rather than in a centralized cloud. This approach eliminates the need for cloud-based data storage and processing, ensuring that both privacy preservation and local, user-specific model updates are prioritized, meeting the increasing demand for data security and personalized functionality in endpoint devices.

The currently disclosed technique may enable enhanced and customized machine learning experiences for users without compromising privacy, as all learning and inference occur on the user's device. Further, the currently disclosed technique may support decentralized distributed machine learning model learning, which eliminates reliance on centralized servers and enhances privacy. Further, the currently disclosed technique may utilize advanced machine learning model chipsets (such as NPU and GPU) and demonstrate the capabilities and advantages of Intel's hardware for local machine learning processing. Further, the currently disclosed technique.

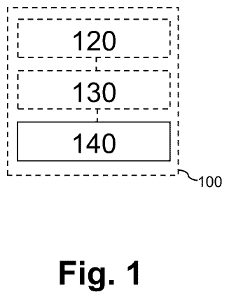

FIG. 1 illustrates a block diagram of an example of a non-transitory computer-readable medium 140. The non-transitory computer-readable medium 140 stores instructions that, when executed by one or more processing circuitries 130 of an apparatus 100, causes the one or more processing circuitries 130 to perform, locally on the apparatus 100, a method for locally training a pretrained machine learning model. The one or more processing circuitries 130 may access the non-transitory computer-readable medium 140 via an interface circuitry 120. In some examples, the non-transitory computer-readable medium 140 may be included in an apparatus 100, which may also comprise the one or more processing circuitries 130. In some examples, the one or more processing circuitries 130 may be distributed over a plurality of apparatuses and may for example, access the non-transitory computer-readable medium 140 via the interface circuitry 120.

For example, the non-transitory computer-readable medium may refer to any tangible, physical medium capable of storing instructions, data, or other types of information for access by a computer, processor, or similar electronic device. The computer-readable medium may be non-transitory in that medium may have a persistent or enduring form. The non-transitory computer-readable medium may comprise one or more of the following computer-readable mediums: magnetic storage devices, such as hard disk drives (HDDs) and magnetic tapes, which store data using magnetic patterns and are commonly used for long-term data storage in computers, servers, and backup systems. Optical storage media, including compact discs (CDs), digital versatile discs (DVDs), and Blu-ray discs, utilize laser technology to read and write data, offering durability and longevity for storing software, media, and backups. More modern forms include solid-state devices (SSD), which rely on flash memory technology without moving parts, such as USB flash drives, secure digital (SD) cards, and internal/external SSDs, valued for their fast read/write speeds and portability. Additionally, non-volatile memory chips like read-only memory (ROM) and programmable ROM (PROM) store critical firmware or embedded software, commonly found in embedded systems and computers. Advanced memory technologies, such as phase-change memory (PCM), magnetoresistive RAM (MRAM), and ferroelectric RAM (FeRAM), offer persistent data storage with high reliability, speed, and power efficiency, making them ideal for applications requiring rapid access and data retention, such as in mobile devices, high-performance computing, and industrial systems.

For example, the one or more processing circuitries 130 may access the non-transitory computer-readable medium 140 over the interface circuitry 120 of the apparatus 100. For example, the one or more processing circuitries 130 may then execute the instructions stored on the non-transitory computer-readable medium 140 of the apparatus 100. The execution of the instructions stored on the non-transitory computer-readable medium 140 causes the one or more processing circuitries 130 to perform locally on the apparatus 100 the method for locally training a pretrained machine learning model.

The method comprises obtaining a pretrained machine learning model by the apparatus 100. The method further comprises generating training data based on user-related information. The user-related information relating to a user behavior during interaction of the user with the apparatus 100. The method further comprises training the pretrained machine learning model based on the generated training data by the apparatus to obtain a personalized machine learning model. The method further comprises executing the personalized machine learning model by the apparatus 100. The data generation, training of the pretrained machine learning model and/or executing of the personalized machine learning model are performed locally on the apparatus 100.

In some examples, the apparatus 100 may be at least one of the following: a personal device, an endpoint device, a personal computer, a laptop, a tablet, or a cell phone. A personal device may refer to a computing device primarily intended for individual use. For example, the personal device may be operated directly by a single user. A personal device may a smartphone, laptop, tablet, and personal computer, and may be used for tasks such as communication, media consumption, and productivity. An endpoint device may refer to a device at the edge of a network that serves as a final access point for network resources and user interaction. An endpoint device include a personal computer, a smartphone, a tablet, an IoT device, and other network-connected hardware. An endpoint device may enable secure, local processing and often interact directly with centralized systems or servers while maintaining some degree of autonomy. In the context of a machine learning model, an endpoint device may perform local inference and processing tasks, enhancing data privacy and reducing latency by operating independently of external servers.

In some examples, the one or more processing circuitries 130 of the apparatus 100 comprise at least one of a neural processing unit (NPU) and/or at least on graphics processing unit (GPU). In some examples, the training (for example, the fine-tuning) of the pretrained machine learning model is executed by the graphics processing unit and the executing (i.e., the inference) of the personalized machine learning is performed by neural processing unit (NPU). That is, the GPU may be responsible for the training phase of the pretrained machine learning model by the apparatus 100, using its high parallel processing capabilities to efficiently adjust the model's weights and biases during training. The NPU may execute the personalized machine learning model during inference, leveraging its design for rapid, low-power calculations that support real-time predictions. In another example, the GPU may be used for inference, or it may be used for training and inference. For example, the NPU may be used for training, or it may be used for training and inference. In some examples, the NPU and/or the GPU may be used for training and/or inference.

The machine learning model may be a mathematical representation or algorithm designed to learn patterns from data and make predictions and/or decisions without being explicitly programmed for a specific task. The machine learning model may an input (such as images, text, or numerical values) and may process these inputs to produce an output that represent classifications, predictions, recommendations etc. The machine learning model may comprise types such as a decision tree, a support vector machine (SVM), a Bayesian model, and/or an artificial neural network (ANN). An ANN may be a type of model that consists of layers of interconnected nodes (neurons) designed to recognize patterns in data by adjusting its internal parameters based on relationships between inputs and outputs. ANNs may be used for tasks like image recognition, language processing, and speech recognition, where the model receives input data (e.g., an image or sentence) and produces an output, such as a label, category, or score, based on learned patterns. Types of ANNs may include feedforward neural networks (FNNs), which may process inputs in a straightforward, layer-by-layer manner to produce outputs; generative adversarial networks (GANs) for generating synthetic data; convolutional neural networks (CNNs), which may process images by focusing on spatial hierarchies within input data; recurrent neural networks (RNNs) and long short-term memory networks (LSTMs), which may handle sequential data by capturing dependencies over time; and transformer networks, which may process sequential input data for tasks like natural language processing (NLP), enabling contextually relevant outputs by leveraging attention mechanisms.

The FNN may comprise a simple, layered topology with nodes arranged sequentially in input, hidden, and output layers, where each layer is fully connected to the next. The nodes may be mathematically modeled to aggregate input values from the previous layer, apply weights and biases, and then use an activation function, such as ReLU or sigmoid, to produce an output. Inputs to the FNN may be fed in as feature vectors, passing sequentially through each layer, with the final output layer producing predictions or classifications. For example, the FNN as provided in a machine learning library like scikit-learn may be used.

The GAN may comprise two neural networks, a generator and a discriminator, that operate in an adversarial relationship. The generator network may take random noise or seed data as input to generate synthetic data samples, while the discriminator network receives both real and synthetic data as input to distinguish between them. Outputs from the generator may be fed as inputs to the discriminator, where the discriminator produces an output that indicates whether the data is real or generated, forcing the generator to improve over time. For example, GANs as provided in machine learning libraries like TensorFlow or PyTorch may be used for generating high-quality, realistic images.

The CNN may be structured with layers designed for spatial data, often including convolutional, pooling, and fully connected layers. Nodes in CNNs may focus on small, localized regions of the input data, allowing them to detect image features. Inputs may be fed into the convolutional layers as image matrices or spatial data, where filters slide over the input to detect patterns. The final output layer may aggregate these detected features to produce classifications, such as identifying objects within an image. For example, CNNs such as AlexNet, VGGNet, ResNet, and Inception may be used.

The RNN may use a looped topology that allows connections back to previous layers, enabling them to process sequences by retaining information over time steps. Each node in an RNN may take in an input at each time step, combine it with the hidden state from the previous step, and apply an activation function, such as tanh, to propagate information forward, capturing dependencies within the sequence. For the LSTM, memory cells with input, forget, and output gates may control the information flow, allowing the network to retain long-term dependencies effectively. Input sequences are fed step-by-step, and the output may be a sequence of predictions or classifications for each time step, making these models suitable for tasks like language translation. For example, RNNs and LSTMs as provided in TensorFlow or PyTorch, such as seq2seq, may be used.

In some examples, the pretrained machine learning model may be a transformer model, a type of ANN architecture designed to handle sequential data, such as natural language, by using an attention mechanism. The transformer network may employ a self-attention mechanism, allowing nodes in each layer to dynamically focus on different parts of the input sequence based on relevance rather than position. Inputs may be fed in as entire sequences rather than one step at a time, with the attention layers analyzing relationships across the entire sequence simultaneously. The output of a transformer model may be contextually enhanced embeddings for each input token or a generated sequence, making it highly effective for tasks like translation or text summarization. For example, popular transformer models like BERT, GPT, and T5 may be used for such applications. The attention mechanism may enable the model to focus on different parts of the input sequence by weighing the importance of words or tokens in relation to one another, without processing the data sequentially as traditional recurrent neural networks or long short-term memory networks do. The transformer model is based on different architectures: encoder-only, decoder-only, and/or encoder-decoder models. Encoder-only transformers, such as Bidirectional Encoder Representations from Transformers (BERT), is designed to process input data bidirectionally, meaning they capture context from both the left and right sides of a word to better understand its meaning in a given sentence. These models may perform well on tasks such as text classification, named entity recognition, and token classification, where understanding the input context is crucial. Decoder-only transformers, like Generative Transformers (GPT), is designed for text generation tasks. They work by processing input text in an auto-regressive manner, meaning they generate the next word in a sequence based on all the previous words. Decoder-only models may perform well for tasks like text generation, dialogue generation, and summarization. Lastly, encoder-decoder transformers, such as Text-to-Text Transfer Transformers (T5) and Bidirectional and Auto-Regressive Transformers (BART), combine both an encoder to process the input and a decoder to generate output. They perform well on sequence-to-sequence tasks such as machine translation, summarization, and text-to-text transformation tasks.

The pretrained machine learning model may refer to a machine learning model that has been initially trained on a general dataset to learn foundational patterns, structures, and relationships within the data before being fine-tuned for specific tasks or users. This pretraining process may involve exposing the machine learning model to extensive data from the target domain—such as text for language tasks or images for visual tasks—allowing it to develop representations or embeddings that capture essential features. For instance, a model intended for natural language processing may be pretrained on a large text corpus, enabling it to recognize grammar, syntax, and common word associations, while a model for image processing may learn visual features like edges and textures. Pretraining builds a robust base of knowledge, so when the model is later fine-tuned with smaller, user-specific data, it can adapt quickly and accurately to specialized tasks.

For example, the pretrained machine learning model may be a pretrained small language model (SLM). An SLM may refer to a machine learning model, such as a transformer, designed for natural language processing tasks and capable of being operated efficiently—meaning for both training and inference—on a standard personal computer. An SLM may have a limited number of parameters, for example, fewer than 1*10\hat{ }10 parameters, enabling it to perform NLP tasks like text classification, summarization, or personalized recommendations without the extensive computational resources required for larger models. The SLM may be pretrained on large datasets to learn general language patterns, syntactic structures, and semantic relationships. The SLM may be a pretrained model such as DistilBERT (with 66 million parameters), GPT-2 Small (with 117 million parameters). Another example, of a SLM is the “T5 small” model, which may have for example 60 million parameters (see also the paper: Raffel, Colin, et al. “Exploring the limits of transfer learning with a unified text-to-text transformer.” Journal of machine learning research 21.140 (2020): 1-67). These examples are pretrained SLMs that have been optimized to perform well on a variety of NLP tasks and can be further fine-tuned on specific, smaller datasets to adapt to particular applications or users. The transformer-based SLMs are configured to run on consumer-grade PCs, where they process user data locally to personalize outputs, such as notification handling, offering an efficient balance of computational performance and personalization.

In some examples, the pretrained machine learning model may have less than 1*10\hat{ }10 parameters. In another example, the pretrained machine learning model may refer to a machine learning model which may be operated efficiently on a standard personal device (such as a PC or a smartphone). For instance, this may comprise performing one training iteration (for example one iteration of supervised learning) on the pretrained machine learning model by the apparatus 100 in less than 10 seconds. In another example, the training to personalize the pretrained machine learning model may take less than 6 hours (for example on a GPU). In another example, the this may comprise performing one inference step of the personalized machine learning model by the apparatus 100 in less than 200 milliseconds.

The training of the machine learning model—the pretraining as well as the training of the pretrained machine learning model—may involve feeding it training data and allowing it to adjust internal parameters, such as weights and biases in an ANN, to improve its accuracy or other performance metrics over time. The model's training process may vary based on the learning type, including supervised learning, unsupervised learning, reinforcement learning, and semi-supervised learning. In supervised learning, the model may be provided with labeled data, consisting of input-output pairs, and learns to map inputs to correct outputs by minimizing the error between its predictions and the actual outputs. This process may involve calculating a loss function (such as mean squared error for regression or cross-entropy for classification) and using backpropagation to compute gradients that guide adjustments to each parameter through gradient descent. This iterative adjustment reduces the error over time, gradually improving the model's accuracy.

In unsupervised learning, the model may be given unlabeled data and may identify patterns or structures without explicit guidance. Common tasks may include clustering (grouping similar data points) and dimensionality reduction (finding key features that capture most of the variance). Since there may be no labels, the model's adjustments may aim to reduce a different type of loss, such as minimizing distances between points in the same cluster. Backpropagation may still be used to adjust weights, but the loss functions in unsupervised learning may focus on measures like reconstruction error (in autoencoders) or similarity measures. In semi-supervised learning, the model may combine elements of supervised and unsupervised learning, using a small amount of labeled data along with a large set of unlabeled data to improve training efficiency. Here, the model's adjustments may combine traditional supervised backpropagation on labeled data with clustering or reconstruction techniques on unlabeled data, enhancing generalization. Across all these learning types, backpropagation may be essential for adjusting weights in neural networks, and loss functions may guide the training process to achieve the desired model performance. Reinforcement learning (RL) may involve training a model to make sequences of decisions within an environment to maximize cumulative rewards over time. Rather than labeled input-output pairs, the model may learn from trial and error: it may take an action, receive feedback as a reward or penalty, and update its policy based on this outcome. The training may involve calculating a reward-based objective function and using algorithms like policy gradients or Q-learning to adjust parameters, guiding the model towards actions that maximize long-term rewards. The model may use backpropagation to update its parameters based on the reward gradients, refining its policy iteratively and enabling it to handle dynamic tasks and adapt to changing conditions.

The user-related information relating to a user behavior during interaction of the user with the apparatus 100 may be data gathered from the user's actions, responses, and/or preferences while engaging with the apparatus 100. This information may serve as a record of user interaction patterns and provide insights into how the user interacts with various elements of the apparatus 100, such as, for example, notifications, alerts, and application interfaces. In some examples, the user-related information may capture user behaviors. In some examples, the user-related information may capture the types of notifications a user regularly interacts with, the timing of his engagement, or the feedback he provides, whether explicitly or implicitly. In some examples, the user-related information may comprise details such as how often the user dismisses certain types of notifications without opening them, which notifications prompt immediate interaction, what times of day the user is more likely to engage with system prompts, and responses to alerts during specific applications (e.g., dismissing messages during video calls).

The training data used to train the pretrained machine learning model may be generated based on the user-related information. The user-related information may be collected by the apparatus 100 during interaction with the user. For example, the generated training data may comprise a plurality of data instances. Each data instance of the training data may be structured as labeled data, for example for supervised learning or the like. The training data may capture distinct patterns in the user's interactions with the apparatus 100. The generated training data may represent specific examples of user behaviors in relation to notifications, alerts, and applications, with each instance labeled according to the observed response or preference of the user. For instance, each piece of training data may indicate not only that a particular type of notification was dismissed but also the context in which it occurred—such as the time of day, the application currently in use, or the nature of the notification. For example, if the user regularly dismisses social media notifications while using productivity applications, these instances may be labeled as “Dismiss during productivity tasks.” Similarly, notifications that prompt immediate interaction may be labeled with context about the time or application type. Therefore, the training data may encapsulate patterns in the user-related information, forming a training dataset that enables the pretrained model to be personalize itself to the user's preferences and interaction style with apparatus 100.

The pretrained machine learning model is trained to yield the personalized machine learning model, which may refer to a machine learning model that has been specifically adapted to reflect the unique behaviors, preferences, and contexts of an individual user. This training may refer to adapting the pretrained machine learning model that has already been trained on a general dataset to meet the specific behaviors, preferences, and contexts of the individual user. This training of the pretrained machine learning model may comprise fine-tuning and/or reinforcement learning (see below). For example, the pretrained model may be trained using supervised learning with generated labeled training data derived from user-related information and system-specific data. The training data may include details about the user's interaction patterns with notifications, applications, and alerts, as well as contextual data, such as device status (e.g., battery level, CPU usage), application state, and usage patterns (e.g., time of day). Each instance in the training data may pair input parameters (e.g., notification type, user action, and system state) with desired output labels (e.g., whether to display or suppress a notification, display duration, notification priority), creating input-output pairs that guide the pretrained machine learning model's adjustments. This training of the pretrained machine learning model provides it with a foundational adaptation that aligns it with the user's behavior as captured by the training data, allowing it to perform personalized tasks. Therefore, the training of the pretrained machine learning model yields the personalized machine learning model, capable of making decisions and predictions that are specifically tailored to the user's individual context, preferences, and interaction history.

Executing the machine learning model by the apparatus 100 may refer to the process of running the personalized machine learning model to generate predictions, classifications, and/or recommendations based on current input data. This process may also be referred to as inference. During execution, the apparatus 100 may feed new, real-time inputs—such as user actions, system status, or contextual parameters—into the personalized machine learning model, allowing it to produce outputs tailored to the user's preferences and context. This inference happens locally on the apparatus 100, ensuring that the machine learning model operates directly on apparatus 100 without requiring data to be transmitted to external servers, thereby preserving user privacy and enabling responsive, real-time interactions. The local execution of the model makes it possible for the apparatus 100 to dynamically adapt its behavior in response to the user's real-time environment, such as suppressing or prioritizing notifications based on inferred engagement likelihood or adjusting display settings according to system conditions.

In some examples personalized machine learning model is configured to control at least one of an interaction of the apparatus 100 with the user, information on a notification to the user, whether information on a notification is displayed for the user, how long information on a notification is displayed for the user, to which extend information on a notification is displayed for the user, a toasting of a notification to the user. That is pretrained machine learning models is personalized as described above then performing inference (i.e. executing) in order to control the above described interactions. Through the process of executing the personalized model, the inference is conducted locally on the apparatus 100, where real-time input data are used to generate the outputs to control the above interactions.

The interaction of the apparatus 100 with the user may refer to the model's ability to manage and adjust the timing, type, and frequency of interactions based on user context and preferences. For instance, the model may tailor interactions to ensure that only relevant notifications are shown during specific periods, such as presenting work-related alerts during work hours and suppressing social notifications to reduce distractions. The interaction of the apparatus 100 with the user may refer to the model's ability to manage and adjust the timing, type, and frequency of interactions based on user context and preferences. For instance, the model may tailor interactions to ensure that only relevant notifications are shown during specific periods, such as presenting work-related alerts during work hours and suppressing social notifications to reduce distractions. Information on a notification to the user may refer to the model's capacity to control the content presented within each notification, such as displaying only essential information or specific details likely to be of interest to the user. This selective display ensures that notifications are concise and focused, enhancing the relevance and readability of the information provided. Whether information on a notification is displayed for the user may refer to the model's capability to determine if a notification should appear at all based on context and priority. The model may choose to hide or delay notifications during times when the user is busy or less likely to engage, such as during a video call or when using a productivity application. How long information on a notification is displayed for the user may refer to the model's control over the duration that a notification remains visible. The model may adjust the display time according to the importance of the notification and the user's engagement likelihood, extending the duration for critical messages and minimizing it for lower-priority alerts. To what extent information on a notification is displayed for the user may refer to the model's ability to control the level of detail in the notification. For instance, the model may show only a brief summary or headline when the user is focused on other tasks, with an option to expand the notification if the user indicates interest. A toasting of a notification to the user may refer to the model's management of “toast” notifications, which are brief pop-up messages displayed on the screen. The model may control whether and how these toast notifications appear, customizing their duration, style, and position to ensure they are informative but minimally disruptive based on the user's current activity.

In some examples, input parameters to the personalized machine learning model may be detailed data that allows the apparatus 100 to adjust notification handling based on user context and behavior. These input parameters may comprise one or more of the following: the notification type (e.g., social media, work-related, system alert), time of interaction (e.g., morning, during work hours, evening), and user action on notifications (e.g., dismissed, opened, snoozed), allowing the model to learn and predict user preferences in diverse contexts. Additional input parameters may include the current application in focus (e.g., video call application, email client, or productivity software), device status (e.g., low battery, high CPU usage, network connectivity status), and user location (e.g., at work, home, or on the move). Other data points, such as user engagement history (e.g., past frequency of interacting with similar notifications) and feedback signals (e.g., thumbs up or down for specific alerts or interaction preferences), further enrich this dataset, helping the model to tailor outputs that are more relevant to the user's specific needs and circumstances.

In some examples, output parameters of the personalized machine learning model through inference may serve to control various functions of the apparatus 100, adapting its behavior based on the input parameters to create a more personalized user experience. For example, the model may generate notification display decisions (e.g., show or hide a notification based on relevance), enabling the apparatus 100 to selectively present only the most pertinent notifications to the user. Additionally, the output may include display timing adjustments, where the model determines when to delay notifications during high-focus activities or specific time frames, and notification duration settings that extend display time for high-priority notifications while minimizing it for less relevant alerts. The personalized machine learning model may also produce outputs that control notification priority (e.g., prioritizing work-related notifications during working hours) and calculate user engagement likelihood (e.g., a probability score indicating the user's likelihood of interacting with a notification), ensuring that the apparatus only prompts user interaction when it is deemed necessary or likely to be beneficial. Further, the machine learning model may modify interaction settings such as suppressing non-urgent notifications during video calls or bundling notifications when engagement is low, thereby managing notification display in a context-sensitive manner. These output parameters, generated through localized inference on the personalized model, directly control the apparatus 100 to dynamically adapt its notification handling and interactions, ensuring that user engagement aligns with current preferences and context for a seamless experience.

The above-described technique enables enhanced and customized machine learning experiences for users without compromising their privacy by allowing the machine learning model to operate and adapt locally on the user's personal device. Through the integration of local processing on advanced machine learning chipsets, such as an NPU and/or GPU the apparatus 100 may be capable of performing both training and inference without transmitting sensitive user data to external servers. This decentralized, distributed machine learning approach may protect the users privacy while providing a seamless and highly responsive experience. By keeping all data processing and model updates on-device, the invention addresses privacy concerns often associated with cloud-based machine learning, offering an innovative solution that combines personalization with secure data handling.

Further, by enabling immediate inference results locally on the apparatus 100, the above described technique may provide the users with real-time responses, eliminating any potential delays caused by communication with external servers. This on-device processing ensures there are no delays due to communication latency, allowing the machine learning model to dynamically adjust and respond in real-time as the user interacts with it. This enhances the user experience by supporting uninterrupted, immediate interactions. The above described technique may enhance machine learning functionality on personal devices, empowering standard consumer hardware with the performance required for complex, adaptive machine learning applications and enabling functionalities typically associated with more powerful, centralized systems.

In some examples, training of the machine learning model (to obtain the personalized machine learning model) comprises at least one of fine-tuning the pretrained model based on the generated training data or applying reinforcement learning to the pretrained model based on the generated training data. Fine-tuning of the pretrained machine learning model may refer to a supervised training approach where the pretrained machine learning model is adapted using the generated labeled training data that reflects the user's unique behaviors, preferences, and interaction patterns with the apparatus 100. Through this process, the machine learning model's parameters—such as weights and biases—are adjusted to align the model's outputs closely with the user's specific needs. Alternatively, or in addition, reinforcement learning (RL) may be applied, where the machine learning model learns through a trial-and-error process by receiving feedback in the form of rewards or penalties based on the effectiveness of its actions within the user environment. Reinforcement learning may enable the machine learning model to develop a policy—a set of decision-making rules—that maximizes cumulative rewards over time, allowing the model to improve its behavior gradually. Unlike supervised learning, which relies on labeled data, reinforcement learning allows the machine learning model to explore different actions and learn from the outcomes, effectively training it to make better decisions based on feedback from its own interactions. For example, reinforcement learning allows the pretrained machine learning model to adapt its responses in real time based on user-specific feedback. For instance, if the machine learning model decides to suppress a notification during a user's video call, and the user responds favorably by not overriding this action, the model may receive a reward, reinforcing that behavior for similar situations. Conversely, if the user frequently overrides suppression decisions, the model may receive a penalty, encouraging it to adjust its policy to better suit the user's needs. Over time, these reward and penalty signals may guide the model's adjustments, helping it learn the user's preferences in various contexts.

In some examples, the training of the machine learning model comprises fine-tuning the pretrained model based on first data of the generated training data and applying reinforcement learning to the fine-tuned model based on second data of the generated training data. This approach may involve fine-tuning the pretrained model using a first subset of the generated training data, followed by applying reinforcement learning to the fine-tuned model using a second subset of the training data. In the fine-tuning stage, the pretrained model may be adapted with labeled data, such as user interaction patterns, preferences, and system context, to align the model's outputs more closely with the user's specific needs and behaviors. This initial fine-tuning process allows the model to establish a foundational level of personalization based on the user's historical and context-rich data. Once fine-tuned, the machine learning model may undergo reinforcement learning using the second data subset, which enables it to make adjustments in response to real-time interactions and evolving user preferences. By incorporating reinforcement learning alongside fine-tuning, the machine learning model evolves to become a highly responsive and adaptive personalized model, aligning its outputs to the user's real-time preferences and behaviors for a seamless and dynamic interaction experience.

In some examples, the method may further comprise training of the pre-trained machine learning model based on generated training data based on the collected user-related information at a predetermined time. The predetermined time may be strategically chosen to minimize any impact on the apparatus's 100 performance during the user's active periods. By training the pretrained machine learning model based on user interaction data and contextual information during designated times, the method enables the machine learning model to learn and adapt to the user's specific patterns and preferences without interrupting regular device functions. This approach may ensure that training is efficiently integrated into the apparatus system's operation, supporting continuous and dynamic personalization of the machine learning model.

In some examples, the predetermined time may be set when the apparatus is idle and/or based on a user selection (user-defined schedule). For example, the apparatus 100 may train the pretrained machine learning model at times when it is not actively used, such as overnight or during user-selected intervals, reducing any potential strain on resources. The option for user selection provides flexibility, enabling the user to control when the machine learning model updates based on their preferences and needs. Training during idle times or user-designated periods may ensure that the model can undergo regular updates without disrupting the user's experience, allowing it to remain responsive to the latest patterns in user interaction data.

In some examples, the training of the pretrained machine learning model may be divided into sub-training portions executed at different times. This may allow for incremental updates that are spread across multiple time intervals. This division of training into smaller portions supports a more resource-efficient training process, where the apparatus 100 may complete parts of the training sequentially, without requiring prolonged processing periods. By executing these sub-training portions over different times, the method may allow the machine learning model to receive regular, smaller updates based on the most recent user interaction data, maintaining a balance between continuous adaptation and efficient use of the device's processing capabilities. This incremental approach may enable the machine learning model to dynamically evolve in response to user behaviors while minimizing the demand on system resources.

In some examples, the method may further comprise evaluating a performance of the personalized (for example, fine-tuned) machine learning model before replacing the usage of the pretrained machine learning model by the fine-tuned machine learning model. This evaluation process may involve running specific tests or analyses to assess the fine-tuned machine learning model's accuracy, responsiveness, or relevance in handling user interactions based on recent adaptations. By evaluating performance before deployment, the method may ensure that the fine-tuned machine learning model provides improvements over the original pretrained model, aligning more closely with user preferences and interaction patterns while maintaining a reliable and effective user experience.

In some examples, the fine-tuned machine learning model may pass the performance evaluation if the performance exceeds a predetermined threshold. In some examples, the fine-tuned machine learning model may pass the performance evaluation if the performance exceeds a predetermined threshold. This threshold may represent a benchmark set to ensure the model's outputs meet expected standards for accuracy or responsiveness. For instance, the model may be evaluated on metrics such as the precision of notification management, response timing, or prediction relevance to ensure it consistently delivers outputs that align with user expectations. Only when the fine-tuned model's performance surpasses this threshold may it replace the pretrained model, ensuring that the model update genuinely enhances the personalized user experience on the apparatus.

In some examples, if the fine-tuned machine learning model does not meet the performance threshold, the method may either adjust the training parameters or retain the pretrained model for continued usage. This fallback mechanism may provide flexibility, allowing further fine-tuning attempts or parameter adjustments to improve the model's performance. By maintaining the pretrained model in cases where the fine-tuned model does not pass evaluation, the apparatus may safeguard user experience, ensuring consistent and high-quality interactions without disruptions. This method may thus enable a robust update process, where only well-performing models are deployed, enhancing the reliability of the personalization process.

Coming back to generating training data. In some examples, the method may further comprise continuously collecting user-related information. The method may further comprise storing the collected user-related information in a database of the apparatus 100. For example, the database may be part of the storage circuitry 100. The continuous collection may ensure that the database maintains an up-to-date record of the user's behavior patterns, preferences, and responses, allowing it to capture any evolving or context-specific details about the user's interactions. By storing this user-related information locally on the apparatus 100, the data may be securely and efficiently be accessed as needed. This may facilitate the creation of a robust and contextually relevant training dataset without reliance on external systems.

In some examples, the method may further comprise generating an embedding of the user-related information by the apparatus 100. The training data may be based on the embedding of the user-related information. The embedding may refer to a structured numerical representation that captures the semantic relationships within the user-related information. The embedding may encode interactions, preferences, and/or behaviors in a multi-dimensional space. By using embeddings, the apparatus 100 may transform complex behavioral data into a format that the machine learning model may process effectively, retaining the meaning and patterns within the data while enabling efficient computation. The embedding-based approach may allow the apparatus 100 to generate the training data that may reflect nuanced behavioral relationships, supporting more accurate and personalized model adjustments.

In some examples, the generating the training data may be further based on system information of the apparatus 100. The system data may provide additional context that may enrich the behavioral data with relevant technical details. System information may comprise one or more of the following: device status of the apparatus 100 (e.g., battery level, network connectivity, power mode), usage patterns (e.g., time of day, frequency of interaction), application state (e.g., which application is in focus or running in the background), and resource availability (e.g., CPU, GPU, or memory usage). The system status may influence how the user interacts with the apparatus 100. For instance, the user may be more likely to dismiss notifications during low battery or reduce engagement when system resources are limited. By integrating the system information into the training data, the apparatus 100 may gain a deeper understanding of the user's behaviors in different contexts, enabling the model to distinguish between responses that vary based on the system state, such as notification dismissals during high CPU usage or low-battery conditions. For example, the system information may be incorporated into each of the data instance of the generated training data as contextual label or attribute that accompany the user-related data. For example, for each user action recorded, such as dismissing or interacting with a notification, simultaneously the relevant system state at the moment of interaction may be captured. This state information is then appended to the user behavior data as additional features or tags, which provide a richer context for training.

The training data generated for fine-tuning the machine learning model may comprise a multi-dimensional dataset that captures various aspects of user interactions with the apparatus, structured to support personalized notification handling. Each data instance in the training data may include specific labels and attributes based on the input parameters, organized as input-output pairs or contextual records to enable supervised learning. For example, an entry may record the notification type (e.g., “work-related”), the time of interaction (e.g., “morning”), and the user action (e.g., “dismissed”) along with system status data like “low battery” and current application (e.g., “video call app”). This record may then be labeled with a corresponding output parameter, such as “hide notification,” providing the model with a clear example of user behavior in a specific context. Additional records in the training data may reflect variations in behavior, such as the user choosing to open a social media notification in the evening or snoozing an alert during a video call, labeled respectively with output instructions like “show notification” or “delay notification.”

Furthermore, the training data may capture patterns of engagement history and user feedback. For instance, if a user frequently engages with certain types of notifications but dismisses others, these preferences are reflected in the training data with tags like “frequent engagement” or “low engagement,” labeled with corresponding recommendations for future handling. Feedback signals, such as a thumbs up on specific notification types, may also be recorded, tagged with labels like “positive feedback,” and used to reinforce similar behaviors in the output. Additional environmental information (e.g., user location “at work” or “home”) and device conditions (e.g., “high CPU usage”) may further enrich this dataset, allowing the machine learning model to recognize nuanced interactions and adjust responses based on comprehensive user context. This structured, labeled training data enables the model to develop personalized, contextually aware responses, supporting enhanced user experience by aligning notifications with the user's preferences, behaviors, and device status in real-time.

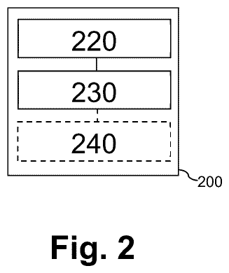

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-8).

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 may comprise one or more components of the non-transitory computer-readable medium 140. For example, the storage circuitry 240 may store instructions that, when executed by the processing circuitry 230, may cause the processing circuitry to perform the method for attestation of a running workload in a trusted execution environment as described above. The storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to obtain a pretrained machine learning model by the apparatus. The apparatus is further configured to generate training data based on user-related information. The user-related information relating to a user behavior during interaction of the user with the apparatus. The apparatus is further configured to train the pretrained machine learning model based on the generated training data by the apparatus to obtain a personalized machine learning model. The apparatus is further configured to execute the personalized machine learning model by the apparatus.

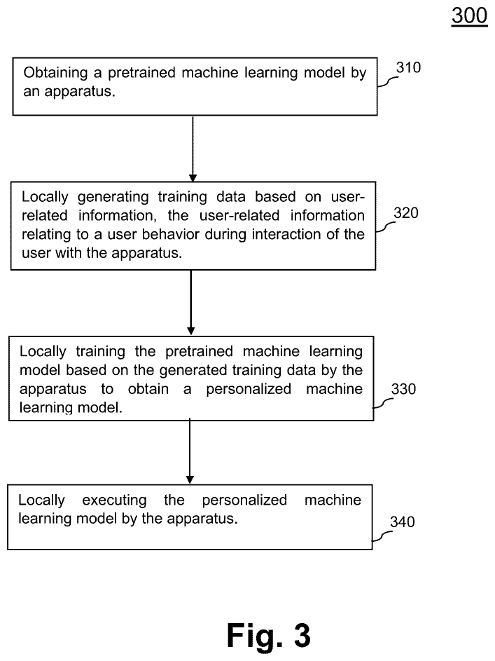

More details and aspects of the apparatus 100 are explained in connection with the proposed technique or one or more examples described above (e.g., with reference to FIG. 1), or below. The apparatus 200 may comprise one or more additional optional features corresponding to one or more aspects of the proposed technique, or one or more examples described above (e.g., FIG. 1) or below (e.g., FIGS. 3-8).

FIG. 3 illustrates a flowchart of an example of a method 300. The method 300 may be performed by an apparatus as described herein, such as apparatus 200. The method 300 may performed by the apparatus 100 (for example the one or more processing circuitries 130), when executing the instructions stored on the non-transitory computer-readable medium described herein, such as the non-transitory computer-readable 140. The method 300 comprises obtaining 310 a pretrained machine learning model by an apparatus. The method 300 further comprises locally generating 320 training data based on user-related information. The user-related information relating to a user behavior during interaction of the user with the apparatus. The method 300 further comprises locally training 330 the pretrained machine learning model based on the generated training data by the apparatus to obtain a personalized machine learning model. The method 300 further comprises locally executing 340 the personalized machine learning model by the apparatus.

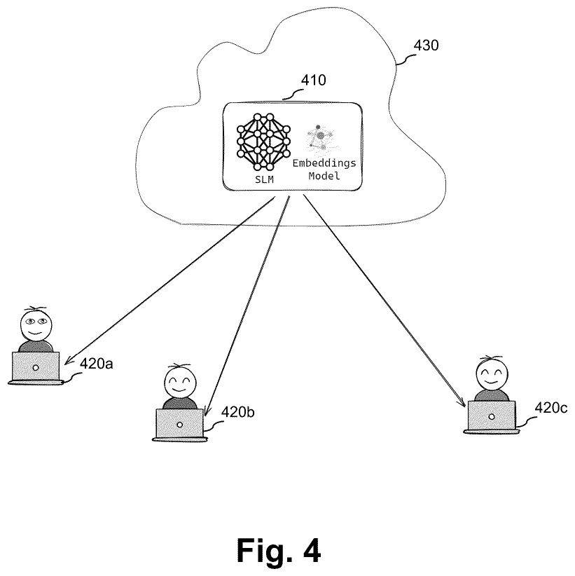

More details and aspects of the method 300 are explained in connection with the proposed technique or one or more examples described above (e.g., with reference to FIG. 1), or below. The method 300 may comprise one or more additional optional features corresponding to one or more aspects of the proposed technique, or one or more examples described above (e.g., FIGS. 1-2) or below (e.g., FIGS. 4-8).

### Further Examples

FIG. 4 illustrates a system for distributing a pretrained machine learning model 410 to edge devices 420. For example, the pretrained machine learning model and embeddings 410 may be stored and initially pretrained in the cloud 430. After pretraining is completed, the pretrained machine learning model 410 is distributed to edge devices 420a, 420b, and 420c. These edge devices, or other user devices, may then use local data and actions (behavioral interactions) to allow users to control and perform various actions on their data, under the condition that data used for fine-tuning the pretrained machine learning model 410 or for inference does not leave the user device (remaining within the customer system perimeter). Examples of data may include SMS messages, app notifications, files, images, and more. Examples of actions may include toasting (pop-up) notifications for new messages and emails, managing files and images, or organizing pictures and videos stored on the system. This data and these actions may be referred to as customer data and actions. The edge device 420 may capture the user's personalized experience by observing their interactions with this data.

An example scenario might involve personalizing the toasting (pop-up) of notifications based on the user's preferences. Through fine-tuning, the machine learning model may learn user preferences regarding which notifications to toast, which to suppress, and the ideal timing for these actions. To learn this preference, private information about the user may be collected, such as notification text, time of interaction, the application in focus at the time (e.g., a user may not want interruptions during a Teams meeting), the user's interaction with the toast notification (such as replying to an SMS), and user feedback (for instance, if the user marked a notification as one that should have been toasted or not). This feedback may be used to annotate the collected data and may also support reinforcement learning of the model through a continuous fine-tuning process.

The following process may be performed: The pretrained SLM 410 is downloaded and installed as a separate package that includes the pretrained machine learning model (for example, the SLM) 410. The machine learning model 410 arrives on the user's system with default behaviors, such as default notification filtering capabilities. These default capabilities are general and the same for all users at the time of initialization. After installation, the device 420 begins collecting data and the user's feedback, based on user consent, with the assurance that data never leaves device 420 and that privacy is preserved, as no data is transmitted to any external cloud/server 430 or any other external server. Based on the collected user behavior and feedback, annotated training data is generated. Once device 420 has accumulated enough data, a fine-tuning process begins to train the machine learning model on this generated data. To protect user privacy, personalization learning is performed locally on the user's system, ensuring that the data never leaves the device. An evaluation process may then assess when the machine learning model 410 has completed learning and may evaluate the model's quality. Once the fine-tuning process is completed, the machine learning model 410 is adjusted to align with the user's preferences. This cycle of accumulating data and fine-tuning may run at preset intervals to continuously improve the model. Additionally, reinforcement learning may be applied, using the user's personal data, analytics, and behavioral information, to further refine the model's capabilities over time.

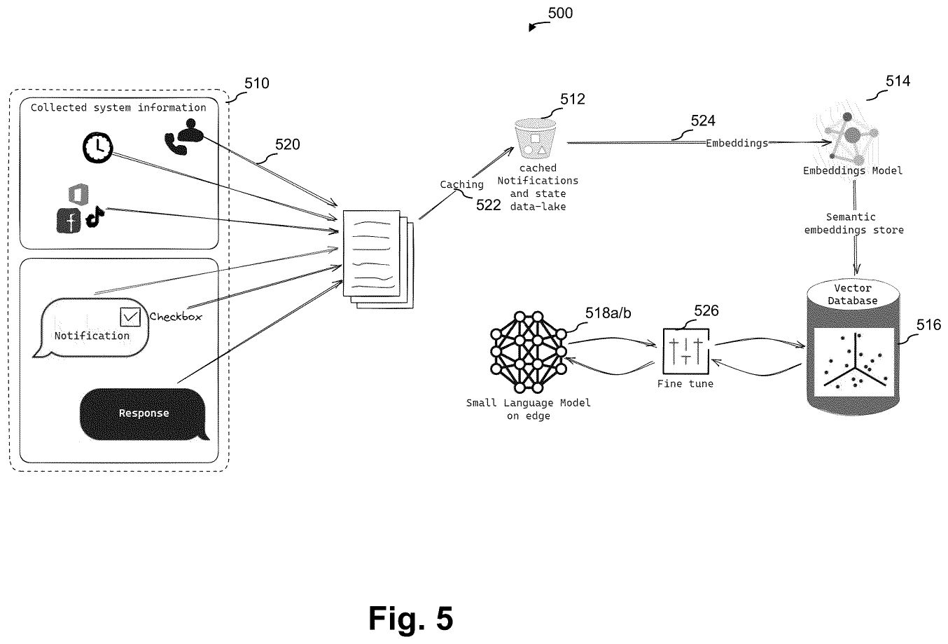

FIG. 5 illustrates a flowchart 500 of a fine-tuning process for a pretrained machine learning model to control toast notifications. In step 520, user-related information 510 regarding toast notifications (for example, from various apps) is collected by the user device. In step 522, the user-related information is cached together with the notifications and system information in a data lake 512. In step 524, based on the collected information, an embedding 514 is generated, which is stored in the vector database 516. Once enough data has accumulated in the database 516, the process may proceed with the fine-tuning in step 526. In step 526, based on the stored embeddings 514, the pretrained machine learning model 518a is fine-tuned. This process may be repeated several times, resulting in a personalized, fine-tuned machine learning model 518b.

The fine-tuning process may consume a significant amount of power from the user device and may take some time to complete. The fine-tuning may be performed on an NPU or GPU of the user device. Because the fine-tuning process may affect the overall performance of the user device, the above-described technique may set a specific time for the fine-tuning process to take place. The fine-tuning process may use various optimization methods to minimize the impact on the user device's resources as much as possible. To reduce the amount of memory required on the GPU, machine learning model quantization techniques may be employed, enabling the fine-tuning process to be performed on the device's NPU. To shorten the learning time, the fine-tuning process may also be divided into smaller intervals, where only partial learning occurs in each interval. For example, if the user schedules fine-tuning to occur during their lunch break on workdays, a partial fine-tuning process may be executed each lunchtime until the evaluation check confirms that the model's inference accuracy has surpassed a preset threshold.

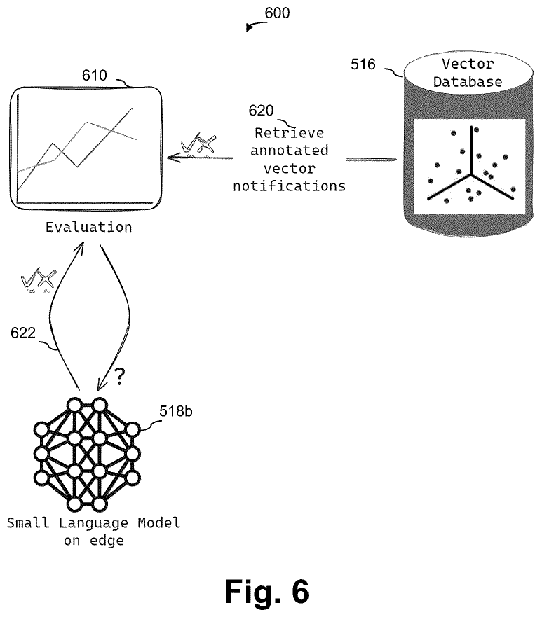

FIG. 6 illustrates the evaluation process 600 of a fine-tuned machine learning model 518b. In step 620, newly accumulated annotated data from the vector database 516 is retrieved by the evaluation engine 610. In step 622, the fine-tuned machine learning model 518b is evaluated against the (yet unseen) retrieved annotated data. The retrieved annotated data is input into the fine-tuned machine learning model 518b for an inference step, and the output is compared against an expected result. This may be repeated for several data instances. If all differences between the expected results and the actual results are below a predefined threshold, the fine-tuned machine learning model may pass the performance evaluation and may be employed for inference.

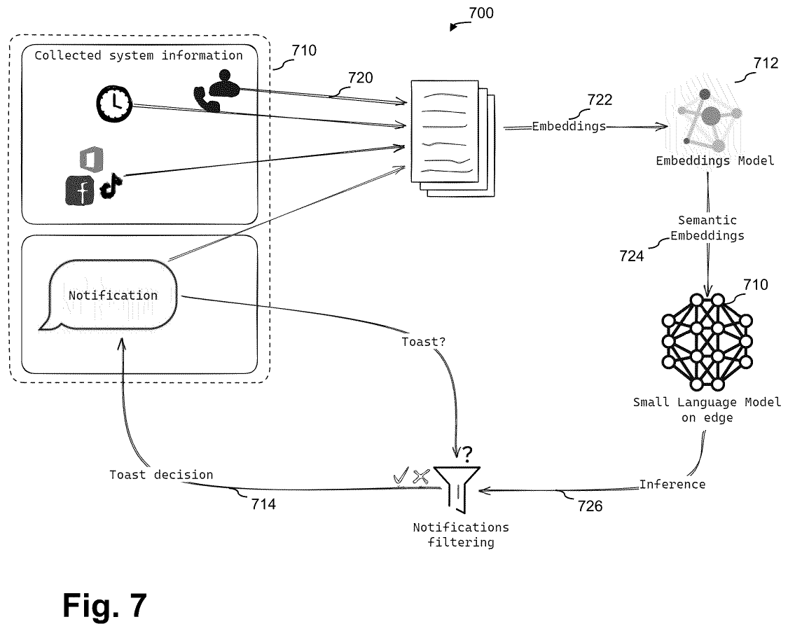

FIG. 7 illustrates a flowchart 700 of an inference step for a fine-tuned machine learning model 518b to control a toast notification. In step 720, user-related information 710 regarding toast notifications is received as input data. In step 722, an embedding 712 may be generated based on the input data 710. In step 724, a semantic search is performed on the embedding 712. In step 726, the embedding 712 is input into the fine-tuned machine learning model 518b, and the inference is performed. The output of the machine learning model 518b is the toast decision 714. The toast decision is then applied in the notification filtering step 728, which receives the toast notification question and the toast decision and applies the decision to the notification.

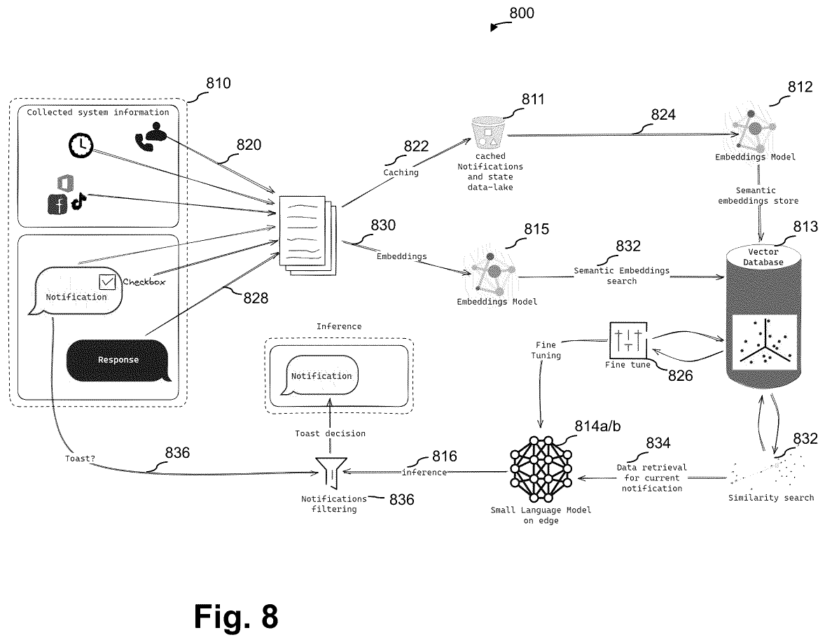

FIG. 8 illustrates a flowchart 800 of the fine-tuning of a pretrained machine learning model and the inference of the fine-tuned machine learning model for controlling a toast notification. The flowchart 800 in FIG. 8 combines the steps of FIGS. 5 and 7 and comprises both a fine-tuning process and an inference process. First, the fine-tuning process is described: In step 820, user-related information 810 regarding toast notifications (for example, for various apps) is collected by the user device. In step 822, the user-related information is cached together with notifications and system information in a data lake 811. In step 824, based on the collected information, an embedding 812 is generated and stored in the vector database 816. Once enough data has accumulated in the database 813, the process may proceed with the fine-tuning in step 826. In step 826, based on the stored embeddings 814, the pretrained machine learning model 814a is fine-tuned. This process may be repeated several times, resulting in a personalized, fine-tuned machine learning model 814b.

After the personalized, fine-tuned machine learning model 814b is obtained, an inference process may be performed. In step 828, user-related information regarding toast notifications is received as input data. In step 830, an embedding 815 may be generated based on the input data. In step 832, a semantic search and/or similarity search is performed on the embedding 815. In step 834, the embedding 815 is input into the fine-tuned machine learning model 814b, and the inference is performed. The output of the machine learning model 814b is the toast decision 816. The toast notification decision 816 is then applied in the notification filtering step 836, which receives the toast notification question and the toast decision and applies the decision to the notification.

In the following, some examples of the proposed concept are presented:

An example (e.g., example 1) relates to a non-transitory computer-readable medium storing instructions that, when executed by one or more processing circuitries of an apparatus, causing the one or more processing circuitries to perform locally on the apparatus a method comprising obtaining a pretrained machine learning model by the apparatus, generating training data based on user-related information, the user-related information relating to a user behavior during interaction of the user with the apparatus, training the pretrained machine learning model based on the generated training data by the apparatus to obtain a personalized machine learning model, and executing the personalized machine learning model by the apparatus.

Another example (e.g., example 2) relates to a previous example (e.g., example 1) or to any other example, further comprising that the data generation, training of the pretrained machine learning model and executing of the personalized machine learning model are performed locally on the apparatus, wherein the user-related information are kept private on the apparatus.

Another example (e.g., example 3) relates to a previous example (e.g., one of the examples 1 to 2) or to any other example, further comprising that the method further comprises training of the pre-trained machine learning model based on generated training data based on the collected user-related information at a predetermined time.

Another example (e.g., example 4) relates to a previous example (e.g., example 3) or to any other example, further comprising that the predetermined time is set when the apparatus is idle and/or based on a user selection.

Another example (e.g., example 5) relates to a previous example (e.g., one of the examples to 4) or to any other example, further comprising that the training of the pretrained machine learning model is divided into sub-training portions executed at different times.

Another example (e.g., example 6) relates to a previous example (e.g., one of the examples to 5) or to any other example, further comprising that the apparatus is at least one of the following a personal device, an endpoint device, a personal computer, a laptop, a tablet, or a cell phone.

Another example (e.g., example 7) relates to a previous example (e.g., one of the examples to 6) or to any other example, further comprising that performing one training iteration on the pretrained machine learning model by the apparatus takes less than 10 seconds.

Another example (e.g., example 8) relates to a previous example (e.g., one of the examples to 7) or to any other example, further comprising that performing one inference step of the personalized machine learning model by the apparatus takes less than 200 milliseconds.

Another example (e.g., example 9) relates to a previous example (e.g., one of the examples to 8) or to any other example, further comprising that the training of the machine learning model comprises at least one of fine-tuning the pretrained model based on the generated training data or applying reinforcement learning to the pretrained model based on the generated training data.

Another example (e.g., example 10) relates to a previous example (e.g., one of the examples 1 to 9) or to any other example, further comprising that the training of the machine learning model comprises fine-tuning the pretrained model based on first data of the generated training data and applying reinforcement learning to the fine-tuned model based on second data of the generated training data.

Another example (e.g., example 11) relates to a previous example (e.g., one of the examples 1 to 10) or to any other example, further comprising that the method further comprises continuously collecting user-related information, and storing the collected user-related information in a database of the apparatus.

Another example (e.g., example 12) relates to a previous example (e.g., one of the examples 1 to 11) or to any other example, further comprising that the method further comprises generating an embedding of the user-related information by the apparatus, the training data being based on the embedding of the user-related information.

Another example (e.g., example 13) relates to a previous example (e.g., one of the examples 1 to 12) or to any other example, further comprising that generating the training data is further based on system information of the apparatus.

Another example (e.g., example 14) relates to a previous example (e.g., one of the examples 1 to 13) or to any other example, further comprising that the personalized machine learning model is configured to control at least one of an interaction of the apparatus with the user, information on a notification to the user, whether information on a notification is displayed for the user, how long information on a notification is displayed for the user, to which extend information on a notification is displayed for the user, a toasting of a notification to the user.

Another example (e.g., example 15) relates to a previous example (e.g., one of the examples 1 to 14) or to any other example, further comprising that the pretrained machine learning model has less than 1*10\hat{ }10 parameters.

Another example (e.g., example 16) relates to a previous example (e.g., one of the examples 1 to 15) or to any other example, further comprising that the one or more processing circuitries of the apparatus comprise at least one of a neural processing unit or a graphics processing unit, and wherein the training of the pretrained machine learning model is executed by the graphics processing unit and the executing of the personalized machine learning is performed by neural processing unit.

Another example (e.g., example 17) relates to a previous example (e.g., one of the examples 1 to 16) or to any other example, further comprising that the method further comprises evaluating a performance of the fine-tuned machine learning model before replacing the usage of the pretrained machine learning model by the fine-tuned machine learning model.

Another example (e.g., example 18) relates to a previous example (e.g., one of the examples 1 to 17) or to any other example, further comprising that the fine-tuned machine learning model passes the performance evaluation if the performance exceeds a predetermined threshold.

Another example (e.g., example 19) relates to a previous example (e.g., one of the examples 1 to 18) or to any other example, further comprising that the pretrained machine learning model is based on a transformer neural network model or a recurrent neural network model.

An example (e.g., example 20) relates to a method for locally training a pretrained machine learning model, the method comprising obtaining a pretrained machine learning model by an apparatus, locally generating training data based on user-related information, the user-related information relating to a user behavior during interaction of the user with the apparatus, locally training the pretrained machine learning model based on the generated training data by the apparatus to obtain a personalized machine learning model, and locally executing the personalized machine learning model by the apparatus.

An example (e.g., example 21) relates to an apparatus for locally training a pretrained machine learning model comprising interface circuitry, machine-readable instructions and processing circuitry to execute the machine-readable instructions to obtain a pretrained machine learning model by the apparatus, generate training data based on user-related information, the user-related information relating to a user behavior during interaction of the user with the apparatus, train the pretrained machine learning model based on the generated training data by the apparatus to obtain a personalized machine learning model, and execute the personalized machine learning model by the apparatus.

Another example (e.g., example 22) relates to a previous example (e.g., example 21) or to any other example, further comprising that the data generation, training of the pretrained machine learning model and executing of the personalized machine learning model are performed locally on the apparatus, wherein the user-related information are kept private on the apparatus.

Another example (e.g., example 23) relates to a previous example (e.g., one of the examples 21 to 22) or to any other example, further comprising that the processing circuitry is further to execute the machine-readable instructions to train the pre-trained machine learning model based on generated training data based on the collected user-related information at a predetermined time.

Another example (e.g., example 24) relates to a previous example (e.g., example 23) or to any other example, further comprising that the predetermined time is set when the apparatus is idle and/or based on a user selection.

Another example (e.g., example 25) relates to a previous example (e.g., one of the examples 21 to 24) or to any other example, further comprising that the training of the pretrained machine learning model is divided into sub-training portions executed at different times.

Another example (e.g., example 26) relates to a previous example (e.g., one of the examples 21 to 25) or to any other example, further comprising that the apparatus is at least one of the following a personal device, an endpoint device, a personal computer, a laptop, a tablet, or a cell phone.

Another example (e.g., example 27) relates to a previous example (e.g., one of the examples 21 to 26) or to any other example, further comprising that performing one training iteration on the pretrained machine learning model by the apparatus takes less than 10 seconds.

Another example (e.g., example 28) relates to a previous example (e.g., one of the examples 21 to 27) or to any other example, further comprising that performing one inference step of the personalized machine learning model by the apparatus takes less than milliseconds.

Another example (e.g., example 29) relates to a previous example (e.g., one of the examples 21 to 28) or to any other example, further comprising that the training of the machine learning model comprises at least one of fine-tuning the pretrained model based on the generated training data or applying reinforcement learning to the pretrained model based on the generated training data.

Another example (e.g., example 30) relates to a previous example (e.g., one of the examples 21 to 29) or to any other example, further comprising that the training of the machine learning model comprises fine-tuning the pretrained model based on first data of the generated training data and applying reinforcement learning to the fine-tuned model based on second data of the generated training data.

Another example (e.g., example 31) relates to a previous example (e.g., one of the examples 21 to 30) or to any other example, further comprising that the processing circuitry is further to execute the machine-readable instructions to continuously collect user-related information, and store the collected user-related information in a database of the apparatus.

Another example (e.g., example 32) relates to the processing circuitry is further to execute the machine-readable instructions to generate an embedding of the user-related information by the apparatus, the training data being based on the embedding of the user-related information.

Another example (e.g., example 33) relates to a previous example (e.g., one of the examples 21 to 32) or to any other example, further comprising that generating the training data is further based on system information of the apparatus.

Another example (e.g., example 34) relates to a previous example (e.g., one of the examples 21 to 33) or to any other example, further comprising that the personalized machine learning model is configured to control at least one of an interaction of the apparatus with the user, information on a notification to the user, whether information on a notification is displayed for the user, how long information on a notification is displayed for the user, to which extend information on a notification is displayed for the user, a toasting of a notification to the user.

Another example (e.g., example 35) relates to a previous example (e.g., one of the examples 21 to 34) or to any other example, further comprising that the pretrained machine learning model has less than 1*10\hat{ }10 parameters.

Another example (e.g., example 36) relates to a previous example (e.g., one of the examples 21 to 35) or to any other example, further comprising that the apparatus comprise at least one of a neural processing unit or a graphics processing unit, and wherein the training of the pretrained machine learning model is executed by the graphics processing unit and the executing of the personalized machine learning is performed by neural processing unit.

Another example (e.g., example 37) relates to a previous example (e.g., one of the examples 21 to 36) or to any other example, further comprising that the method further comprises evaluating a performance of the fine-tuned machine learning model before replacing the usage of the pretrained machine learning model by the fine-tuned machine learning model.

Another example (e.g., example 38) relates to a previous example (e.g., one of the examples 21 to 37) or to any other example, further comprising that the fine-tuned machine learning model passes the performance evaluation if the performance exceeds a predetermined threshold.

Another example (e.g., example 39) relates to a previous example (e.g., one of the examples 21 to 38) or to any other example, further comprising that the pretrained machine learning model is based on a transformer neural network model or a recurrent neural network model.

An example (e.g., example 40) relates to an apparatus comprising a processor circuitry configured to obtain a pretrained machine learning model by the apparatus, generate training data based on user-related information, the user-related information relating to a user behavior during interaction of the user with the apparatus, train the pretrained machine learning model based on the generated training data by the apparatus to obtain a personalized machine learning model, and execute the personalized machine learning model by the apparatus.

An example (e.g., example 41) relates to a device comprising means for processing for obtaining a pretrained machine learning model by the apparatus, generating training data based on user-related information, the user-related information relating to a user behavior during interaction of the user with the apparatus, training the pretrained machine learning model based on the generated training data by the apparatus to obtain a personalized machine learning model, and executing the personalized machine learning model by the apparatus.

Another example (e.g., example 42) relates to a computer program having a program code for performing the method of example 20 when the computer program is executed on a computer, a processor, or a programmable hardware component.

Another example (e.g., example 44) relates to a machine-readable storage including machine readable instructions, when executed, to implement a method or realize an apparatus as claimed in any pending example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries of an apparatus, causing the one or more processing circuitries to perform locally on the apparatus a method comprising:
obtaining a pretrained machine learning model by the apparatus;
generating training data based on user-related information, the user-related information relating to a user behavior during interaction of the user with the apparatus;
training the pretrained machine learning model based on the generated training data by the apparatus to obtain a personalized machine learning model; and
executing the personalized machine learning model by the apparatus.

2. The non-transitory computer-readable medium of claim 1, wherein the data generation, training of the pretrained machine learning model and executing of the personalized machine learning model are performed locally on the apparatus, wherein the user-related information are kept private on the apparatus.

3. The non-transitory computer-readable medium of claim 1, wherein the method further comprises training of the pre-trained machine learning model based on generated training data based on the collected user-related information at a predetermined time.

4. The non-transitory computer-readable medium of claim 3, wherein the predetermined time is set when the apparatus is idle and/or based on a user selection.

5. The non-transitory computer-readable medium of claim 1, wherein the training of the pretrained machine learning model is divided into sub-training portions executed at different times.

6. The non-transitory computer-readable medium of claim 1, wherein the apparatus is at least one of the following: a personal device, an endpoint device, a personal computer, a laptop, a tablet, or a cell phone.

7. The non-transitory computer-readable medium of claim 1, wherein performing one training iteration on the pretrained machine learning model by the apparatus takes less than 10 seconds.

8. The non-transitory computer-readable medium of claim 1, wherein performing one inference step of the personalized machine learning model by the apparatus takes less than 200 milliseconds.

9. The non-transitory computer-readable medium of claim 1, wherein the training of the machine learning model comprises at least one of fine-tuning the pretrained model based on the generated training data or applying reinforcement learning to the pretrained model based on the generated training data.

10. The non-transitory computer-readable medium of claim 1, wherein the training of the machine learning model comprises fine-tuning the pretrained model based on first data of the generated training data and applying reinforcement learning to the fine-tuned model based on second data of the generated training data.

11. The non-transitory computer-readable medium of claim 1, wherein the method further comprises continuously collecting user-related information; and
storing the collected user-related information in a database of the apparatus.

12. The non-transitory computer-readable medium of claim 1, wherein the method further comprises generating an embedding of the user-related information by the apparatus, the training data being based on the embedding of the user-related information.

13. The non-transitory computer-readable medium of claim 1, wherein generating the training data is further based on system information of the apparatus.

14. The non-transitory computer-readable medium of claim 1, wherein the personalized machine learning model is configured to control at least one of an interaction of the apparatus with the user, information on a notification to the user, whether information on a notification is displayed for the user, how long information on a notification is displayed for the user, to which extend information on a notification is displayed for the user, a toasting of a notification to the user.

15. The non-transitory computer-readable medium of claim 1, wherein the pretrained machine learning model has less than 1*10\hat{ }10 parameters.

16. The non-transitory computer-readable medium of claim 1, wherein the one or more processing circuitries of the apparatus comprise at least one of a neural processing unit or a graphics processing unit, and wherein the training of the pretrained machine learning model is executed by the graphics processing unit and the executing of the personalized machine learning is performed by neural processing unit.

17. The non-transitory computer-readable medium of claim 1, wherein the method further comprises evaluating a performance of the fine-tuned machine learning model before replacing the usage of the pretrained machine learning model by the fine-tuned machine learning model.

18. The non-transitory computer-readable medium of claim 1, wherein the pretrained machine learning model is based on a transformer neural network model or a recurrent neural network model.

19. A method for locally training a pretrained machine learning model, the method comprising:
obtaining a pretrained machine learning model by an apparatus;
locally generating training data based on user-related information, the user-related information relating to a user behavior during interaction of the user with the apparatus;
locally training the pretrained machine learning model based on the generated training data by the apparatus to obtain a personalized machine learning model; and
locally executing the personalized machine learning model by the apparatus.

20. An apparatus for locally training a pretrained machine learning model comprising interface circuitry, machine-readable instructions and processing circuitry to execute the machine-readable instructions to:
obtain a pretrained machine learning model by the apparatus;
generate training data based on user-related information, the user-related information relating to a user behavior during interaction of the user with the apparatus;
train the pretrained machine learning model based on the generated training data by the apparatus to obtain a personalized machine learning model; and
execute the personalized machine learning model by the apparatus.
